(19) United States
(12) Patent Application Publication
(10) Pub. No.: US 2002/0109742 A1
(43) Pub. Date: Aug. 15, 2002

(54) Ink jet recording apparatus and recording control method thereof

(76) Inventor: Tetsuto Kageyama, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/068,981

(22) Filed: Feb. 11, 2002

(30) Foreign Application Priority Data
Feb. 15, 2001 (JP) 038476-2001
Jan. 28, 2002 (JP) 018529-2002

(51) Int. Cl. B41J 23/00

(52) U.S. Cl. 347/14; 347/37

(57) ABSTRACT

An ink jet recording apparatus comprises a recording head for recording data on a recording medium by discharging ink from a plurality of discharge ports, a carriage having the recording head mounted thereon for reciprocally scanning the surface of said recording medium, recording medium carrying means for carrying said recording medium by a predetermined distance in the direction perpendicular to said scanning direction of the carriage each time the carriage reciprocally scans the surface of said recording medium, an ink storage tank placed in a position where reciprocal scanning by said carriage and carrying of said recording medium by said recording medium carrying means are not affected by the ink storage tank, a supply tube for supplying ink from the ink storage tank to said recording head, and said control means for controlling ink discharge states of said recording head in accordance with an image signal input from a host computer, wherein said control means controls the scanning speed of said carriage in accordance with the temperature of the ink supplied from said ink tank to said ink supply tube.

### BACKGROUND OF THE INVENTION

1.Field of the Invention

The present invention relates to an ink supply device for supplying ink to a recording head used for an ink jet recording apparatus and an ink jet recording apparatus comprising the ink supply device and, more particularly, to an ink jet recording apparatus comprising a tube for supplying ink from an ink tank to a recording head and a recording control method thereof.

2. Related Background Art

It has been required so far to increase an ink tank in capacity in order to decrease the ink-tank exchange frequency of an ink jet recording apparatus for performing printing by reciprocating a recording head mounted on a carriage. However, because the inertial of an ink tank and the like mounted on a carriage increases in the case of a simple recording-head-integrated type. Therefore, ink is supplied by setting an ink tank to a position that does not move, connecting a tube or the like to a recording head on a carriage, and using various pumps.

In the case of a supply tube, a pressure loss is increased due to the inside diameter of the tube, the flow rate of ink, and particularly increase of the viscosity of the ink flowing at a low temperature and it is impossible to continue printing because an ink supply quantity becomes insufficient. Therefore, it is necessary to set the inside diameter of the tube to a large value in order to reduce the pressure loss even at an assumed low temperature.

However, in the case of the conventional method for setting the inside diameter of a tube so that ink can be sufficiently supplied even at a low temperature, the maximum ink passing quantity of a supply tube is extremely increased due to increase of the printing speed of a printer and increase of the number of simultaneous-discharge nozzles and the supply tube becomes thicker in accordance with increase of an ink viscosity. Thereby, the tube rigidity rises, the malleability is deteriorated, the bend radius of the tube for routing must be increased, and thus, it is difficult to downsize an apparatus. Moreover, an ink jet printer for performing printing by making a carriage perform scanning has problems that rocking of ink is increased due to scanning by the carriage due to the increase in amount of ink present in the movable tube to cause printing irregularity due to pressure fluctuation of an ink inertia.

### SUMMARY OF THE INVENTION

The present invention is made to solve the above problems and its object is to provide an ink jet recording apparatus capable of preventing printing irregularity due to rise of the pressure in a supply tube without increasing the inside diameter of the supply tube and a recording control method thereof. The present inventor pays attention to the fact that a printing apparatus are actually almost operated in an atomosphere temperature of approximately 15° C. or higher. Then, the inventor finds that an ink supply quantity is compensated by setting the minimum supply-tube inside diameter in accordance with the ink viscosity at, for example, 15° C. and when it is determined that a printing error occurs due to an insufficient ink supply quantity because the atmosphere temperature becomes lower than 15° C. and the pressure loss rises, increasing a discharge interval in accordance with the determination to downsize the supply tube and other constitutions.

An ink jet recording apparatus of an embodiment of the present invention is an ink jet recording apparatus comprising a recording head for recording data on a recording medium by discharging ink from a plurality of discharge prots, a carriage having the recording head mounted thereon for reciprocally scanning the surface of the recording medium, recording medium carrying means for carrying the recording medium by a predetermined distance in the direction perpendicular to the scanning direction of the carriage each time the carriage reciprocally scans the surface of the recording medium, an ink storage tank placed in a position where reciprocal scanning by the carriage and carrying of the recording medium by the recording medium carrying means are not affected by the ink storage tank, a supply tube for supplying ink from the ink storage tank to the recording head, and control means for controlling the ink discharge state of the recording head in accordance with an image signal input from a host computer, wherein the control means controls the scanning speed of the carriage in accordance with the temperature of ink supplied from the ink tank to the ink supply tube.

Because the ink jet recording apparatus of the present invention comprises the control means for controlling the scanning speed of the carriage in accordance with the temperature of ink, it is possible to control the quantity of the ink discharged from the recording head by decreasing the scanning speed of the carriage when the temperature of the ink lowers and thereby, the viscosity of the ink rises and therefore, prevent recording irregularity due to lowering of the ink temperature without increasing the inner diameter of the ink supply tube.

Morever, an ink jet recording apparatus of another embodiment of the present invention is an ink jet recording apparatus comprising a recording head for recording data on a recording medium by discharging ink from a plurality of discharge ports, a carriage having the recording head mounted thereon for reciprocally scanning the surface of the recording medium, recording medium carrying means for carrying the recording medium by a predetermined distance in the direction perpendicular to the scanning direction of the carriage each time the carriage reciprocally scans the surface of the recording medium, an ink storage tank placed in a position where reciprocal scanning by the carriage and carrying of the recording medium by the recording medium carrying means are not affected by the ink storage tank, a supply tube for supplying ink from the ink storage tank to the recording head, and control means for controlling the ink discharge state of the recording head in accordance with an image signal input from a host computer, wherein the control means controls the non-recording time during which no ink is discharged from the recording head in accordance with the temperature of the ink supplied from the ink tank to the ink supply tube.

Moreover, an ink jet recording apparatus of still another embodiment of the present invention is an ink jet recording apparatus comprising a recording head for recording data on an recording medium by discharging ink from a plurality of discharge ports, a carriage having the recording head mounted thereon for reciprocally scanning the surface of the recording medium, recording medium carrying means for carrying the recording medium by a predetermined distance in the direction perpendicular to the scanning direction of the carriage each time the carriage reciprocally scans the surface of the recording medium, an ink storage tank placed in a position where reciprocal scanning by the carriage and carrying of the recording medium by the recording medium carrying means are not affected by the ink storage tank, a supply tube for supplying ink from the ink storage tank to the recording head, and control means for controlling the ink discharge state of the recording head in accordance with an image signal input from a host computer, wherein the control mean controls the repetitive recording scanning frequency by the carriage in accordance with the temperature of the ink supplied from the ink tank to the ink supply tube.

Furthermore, the present invention provides recording control methods using the above recording apparatuses.

A recording control method of an embodiment of the present invention is a recording control method for an ink jet recording apparatus comprising a recording head for recording data on a recording medium by discharging ink from a plurality of discharge ports, a carriage having the recording head mounted thereon for reciprocally scanning the surface of the recording medium, recording medium carrying means for carrying the recording medium by a predetermined distance in the direction perpendicular to the scanning direction of the carriage each time the carriage reciprocally scans the surface of the recording medium, an ink storage tank placed in a position where reciprocal scanning by the carriage and carrying of the recording medium by the recording medium carrying means are not affected by the ink storage tank, a supply tube for supplying ink from the ink storage tank to the recording head, and control means for controlling the ink discharge state of the recording head in accordance with an image signal input from a host computer, wherein the scanning speed of the carriage is lowered when the temperature of the ink supplied from the ink tank to the ink supply tube is lower than a reference temperature.

Moreover, a recording control method of another embodiment of the present invention is a recording control method of an ink jet recording apparatus comprising a recording head for recording data on a recording medium by discharging ink from a plurality of discharge ports, a carriage having the recording head mounted thereon for reciprocally scanning the surface of the recording medium, recording medium carrying means for carrying the recording medium by a predetermined distance in the direction perpendicular to the scanning direction of the carriage each time the carriage reciprocally scans the surface of the recording medium, an ink storage tank placed in a position where reciprocal scanning by the carriage and carrying of the recording medium by the recording medium carrying means are not affected by the ink storage tank, a supply tube for supplying ink from the ink storage tank to the recording head, and control means for controlling the ink discharge state of the recording head in accordance with an image signal input from a host computer, wherein the non-recording time during which no ink is discharged from the recording head is increased when the temperature of the ink supplied from the ink tank to the ink supply tube is lower than a reference temperature.

Furthermore, a recording control method of still another embodiment of the present invention is a recording control method of an ink jet recording apparatus comprising a recording head for recording data on a recording medium by discharging ink from a plurality of discharge ports, a carriage having the recording head mounted thereon for reciprocally scanning the surface of the recording medium, recording medium carrying means for carrying the recording medium by a predetermined distance in the direction perpendicular to the scanning direction of the carriage each time the carriage reciprocally scans the surface of the recording medium, an ink storage tank placed in a position where reciprocal scanning by the carriage and carrying of the recording medium by the recording medium carrying means are not affected by the ink storage tank, a supply tube for supplying ink from the ink storage tank to the recording head, and control means for controlling the ink discharge state of the recording head in accordance with an image signal input from a host computer, wherein the repetitive recording scanning frequency by the carriage is increased when the temperature of the ink supplied from the ink tank to the ink supply tube is lower than a reference temperature.

### BRIEF DESCRIPTION OF THE DRAWINGS

FIG. 1 is a perspective view showing an ink jet recording apparatus to which the present invention can be applied;

FIG. 2 is a block diagram showing a configuration of a control system of an ink jet recording apparatus of a first embodiment of the present invention;

FIG. 3 is a flowchart showing a recording control procedure by the control system shown in FIG. 2;

FIG. 4 is a schematic block diagram showing a second embodiment of the present invention; and

FIG. 5 is a characteristic chart showing a relation between ink temperature and viscosity to which the present invention can be applied.

### DETAILED DESCRIPTION OF THE PREFERRED EMBODIMENTS

Embodiments of the present invention are described below by referring to the accompanying drawings.

(First Embodiment)

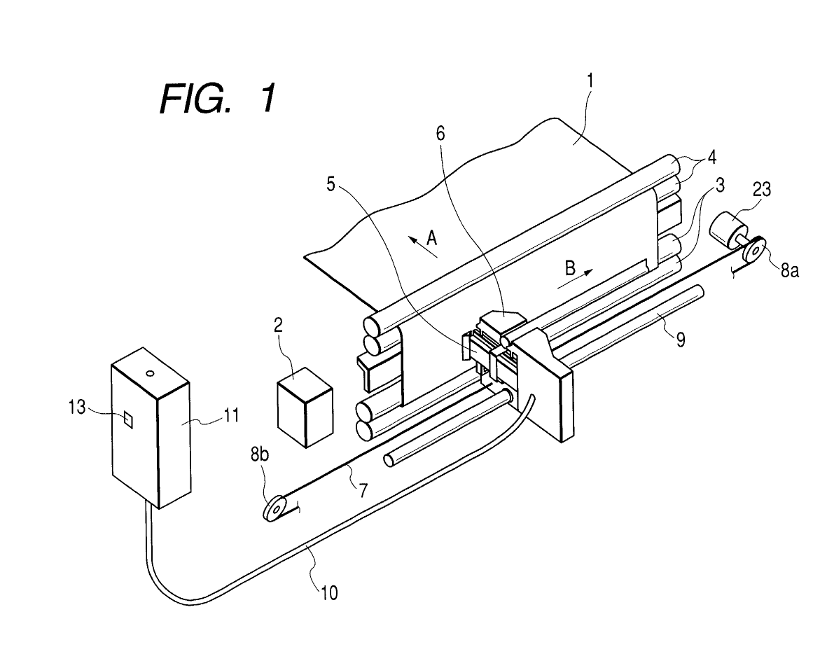

First, the general configuration of a recording apparatus is described below. In FIG. 1, symbol 1 denotes a recording medium made of paper and the like (hereafter referred to as recording sheet). Sheets 1 wound into a roll or carried while mounted on a cassette are supplied to a recording position by a not illustrated sheet supply roller. Moreover, the sheets 1 are carried in the direction of an arrow A by a first carrying roller pair 3 and a second carrying roller pair 4 arranged by keeping a certain interval and respectively driven by a stepping motor (not illustrated). Symbol 5 denotes an ink jet recording head for recording data in the recording sheets 1. Ink is supplied from an ink tank 11 placed in a position which is not scanned to a recording head 5 through a tube 10 and the like and discharged from each discharge port in accordance with an image signal. The recording head 5 is mounted on a carriage 6 and the carriage 6 connects with a carrriage motor 23 through a belt 7 and pulleys 8a and 8b. Therefore, the carriage 6 performs reciprocal scanning along a guide shaft 9 by being driven by a carriage motor 23. A temperature detection sensor 13 is set by contacting or closely to any one of components present in the ink supply path between the ink tank 11 and the recording head 6. Moreover, it is possible to separately set the temperature carriage motor 23. A temperature detection sensor 13 13 can be easily set such as a circuit substrate instead of the above contacting or close position when the temperature in an ink jet printer correlates with an ink temperature.

According to the above configuration, the recording head 5 discharges ink to the recording sheet 1 in accordance with an image signal while moving in the direction of an arrow B to record an image, the recording head 5 returns to the home position according to necessity and repairs a clogged discharge port or the like by recovery system means 2 to improve the discharge state, and the carrying roller pairs 3 and 4 are driven to carry the recording sheets 1 in the direction of the arrow A by one line. By repeating the above operation, desired data is recorded on the recording sheets 1. The recovery system means 2 is constituted by a cap which can be joined to the discharge port formed face of the recording head 5 and a pump communicated to the cap to apply a suction force to the discharge port formed face.

A control system for driving various sections of the above recording apparatus is described below.

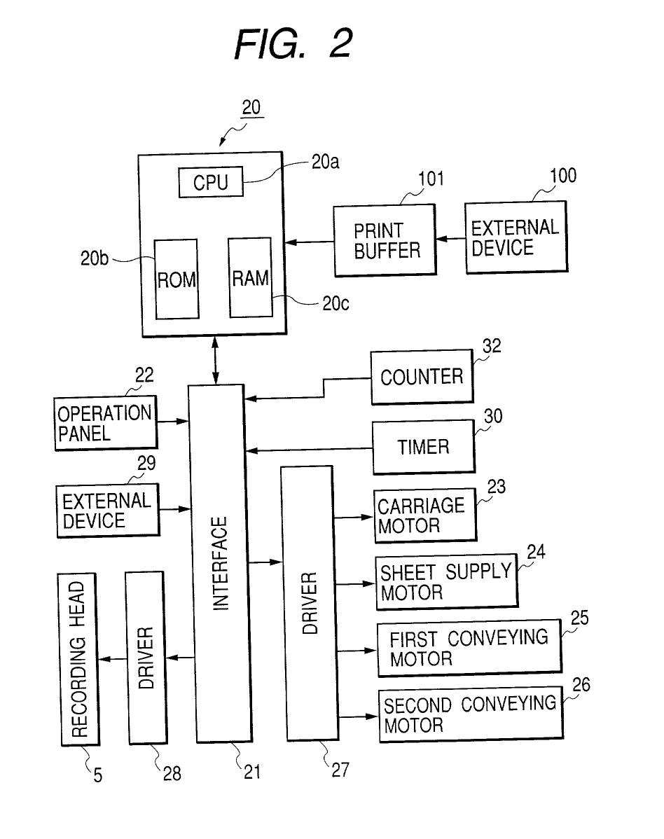

FIG. 2 shows a configuration of the control system which is used as work areas of a CPU 20a such as a microprocessor and a ROM 20b storing a control program of the CPU 20a and various data values and constituted by a control section 20 comprising a RAM 20c for temporarily storing various data values, an interface 21, an operation panel 22, motors (carriage driving motor 23, a motor 24 for driving sheet supply motor, a motor 25 for driving a first carrying roller pair, and a motor 26 for driving a second carrying roller pair), a driver 27 for driving the motors, and a recording-head driving driver 28.

The control section 20 inputs various pieces of information (e.g. character pitch and type of character) from the operation panel 22 through the interface 21 inputs an image signal from an external device 29. Moreover, the control section 20 inputs on- and off-signals for driving the motors 23 to 26 through the interface 21, outputs an image signal, and drives various sections in accordance with image signals.

Moreover, an ink temperature is estimated by a timer 30 and the temperature detection sensor 13 every unit time and transferred to the control section 20 through the interface 21.

This embodiment uses the above configuration to control the pressure in a recording head so that it does not become a set negative pressure or higher, otherwise imperfect discharge occurs when an ink temperature lowers due to the outside air temperature or the like, an ink viscosity rises, and resultantly pressure losses are changed and the negative pressure in the recording head rises.

A configuration for controlling a pressure so that it does not become a set negative pressure or higher is described below.

In the case of an ink jet recording apparatus which has a head having 1,280 discharge ports, discharges the ink of 4.5 pl per dot at a recording rate of 30,000 [dot/sec·discharge port], and performs recording at a duty of 50% for the number of simultaneous discharges, the ink flow rate reaches 86.4 μl/sec. In this case, the pressure loss generated in the whole flow path including tubes and joints is 490 Pa (50 mmAq) or higher and the pressure in a recording head temporarily approaches the so-called choked state in which ink supply does not temporarily catch up with ink consumption particularly due to rise of an ink viscosity at a low temperature. This causes a change of recording densities due to a change of the normal quantity of discharge ink, that is, recording irregularity and in the worst case, cause a state in which no image can be formed because no ink is discharged.

In this case, rise of a negative pressure in a flow path can be controlled by otaining an ink jet printer inside temperature “T” corresponding to an ink viscosity at which ink can be supplied without causing recording irregularity in the ink supply path of the apparatus concerned, previously storing the inside temperature “T” in the ROM 20b, comparing the data for inside temperature transferred from the temperature “T”, and lowering a recording speed when the detected inside temperature exceeds “T”, that is, by controlling a discharge interval.

In this case, it is possible to avoid a negative pressure rise by using a tube having less pressure loss even at an assumed lowest inside temperature such as a tube having a large inside diameter without using the above means. However, the above method raises the rigidity of the tube that must be flexible and it difficult to downsize an apparatus. A general operating condition of an ink jet printer is 15° C. or higher but it is estimated that an operating environment lower than 15° C. is not frequently used. Therefore, the usage of setting a tube inside diameter capable of supplying ink without recording irregularity due to a negative pressure rise at an ink temperature of 15° C., assuming the temperature “T” as a value corresponding to the temperature, and performing the above control only when the data for an inside temperature lower than the temperature “T” is received makes it possible to downsize the apparatus concerned.

Then, an ink jet printer inside temperature “T” corresponding to an ink viscosity at which ink can be supplied without causing recording irregularity in the ink supply path of the apparatus concerned and a specific control method according to the temperature “T” are described below.

First, an inside diameter and a length of a tube estimated from the malleability in accordance with the size of an apparatus are decided. In this case, the inside diameter typically ranges between approximately 1 and 2 mm. It is necessary to select a tube inside diameter and length considering the lower limit of an atmosphere temperature in which the recording apparatus is mainly operated. That is, by setting a condition not choked in most operating temperature ranges, it is possible to effectively use the recording speed of an apparatus. For example, when assuming the lower-limit temperature as 25° C., because the viscosity and density of the ink to be used are decided, the pressure loss in this system becomes a function of the ink flow rate per unit time. The following is a general expression of the function.

Pressure loss P=128 μLQ/(πρgd⁴)

Where

μ: Viscosity (at 2.6×10⁻³Pa·s and 25° C. for typical ink)

ρ: Density (1.07×10³ kg/m³ for typical ink)

g: Gravitational acceleration

π: Ratio of the circumference of a circle to its diameter (a cross-section of the tube is typically circular)

d: Tube inside diameter

L: Tube length

Q: Ink flow rate per unit time

Therefore, in the case of the ink flow rate per unit time necessary for recording, a printing duty mainly decides the above Q when the discharge frequency from a nozzle is constant as described above and a supply path is set which has a pressure loss P not causing a choke when the Q is assumed as the maximum flow rate of an apparatus.

For example, in the case of a recording apparatus having a tube inside diameter of 1 mm, a tube length of 1 m, a maximum duty of 50% (maximum number of simultaneous discharge nozzles of 640), a discharge frequency of 30 KHz, and a discharge quantity of 4.5 per dot, the pressure loss P at the normal delivery is approximately 87 mmAq. This pressure loss of approximately 800 Pa (80 mmAq) is a safe negative pressure not causing a printing trouble in ink jet recording. Thus, it is shown that no printing trouble occurs under the above printing condition even if a recording speed is not controlled at an ink temperature of approximately 25° C. In this case, it is known that the viscosity μ is a function of temperature and it can be calculated in accordance with a high-order polynomial and an experimental coefficient. The pressure loss P has a primary correlation to the viscosity μ as described above. Therefore, a choke state occurs because the pressure loss P proportionally rises when the temperature of ink lowers and the viscosity μ of the ink rises. FIG. 5 shows a typical relation between viscosity and temperature of ink. In the case of this example, the viscosity at 25° C. becomes approximately twofold at 10° C. and the pressure loss P also becomes approximately twofold, and resultantly a choke state occurs. To eliminate the choke state, waiting time is set to 0.2, 0.4, 0.7, and 1.0 sec whenever 25° C. lowers by 5° C. at a safe temperature at which no prining trouble occurs and thereby, scanning is stopped by the waiting time to wait for a negative pressure rise in a tube stops.

It is naturally allowed to lower the recording speed in accordance with the waiting time between scans or in accordance with lowering of the scanning speed. In general, it is easier to lower the recording speed in accordance with the waiting time.

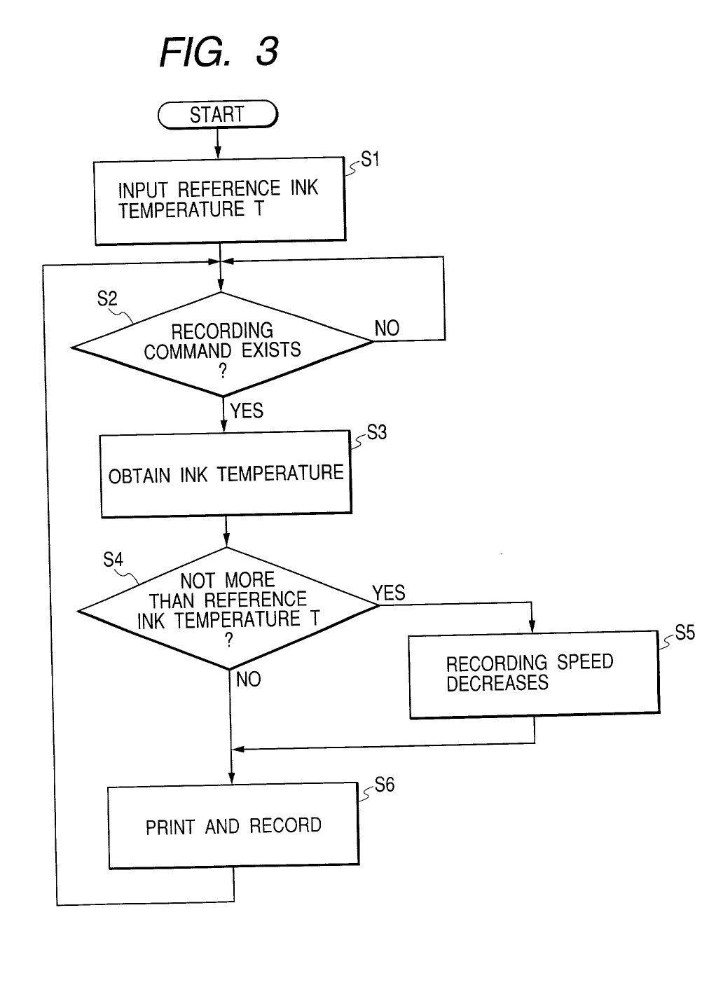

FIG. 3 shows a recording procedure by a recording apparatus comprising the above configuration.

First, a reference ink temperature “T” previously specified in accordance with a supply path capacity is decided (step S1). When a recording instruction is input in step S2, temperature in an apparatus is obtained from the temperature detection sensor 13 instead of an ink temperature (step S3). The obtained temperature in the apparatus is compared with the reference ink temperature “T” at which a negative pressure rise is comparatively small (step S4). If it is determined that the ink temperature is equal to or higher than “T”, print recording is continued (step S6). If it is determined that the ink temperature is lower than “T”, the current recording speed is lowered to a preset recording speed in order to avoid an ink discharge quantity from being decreased due to a negative pressure rise (step S5) to perform print recording (step S6) and then, the current step is returned to step S2 to wait a recording instruction. Specifically, lowering the recording speed represents lowering the discharge frequency for recording (raising the discharge interval) and lowering the canning speed of a recording head corresponding to decreasing the recording speed in the case of a serial-printer-type apparatus like this embodiment.

By performing control as described above, ink is discharged by lowering a necessary ink flow rate at a low temperature at which a negative pressure rise progresses for recording. Therefore, ink deficiency at a recording-head portion, that is, recording irregularity and white streakes are prevented and high image quality can be achieved.

(Second Embodiment)

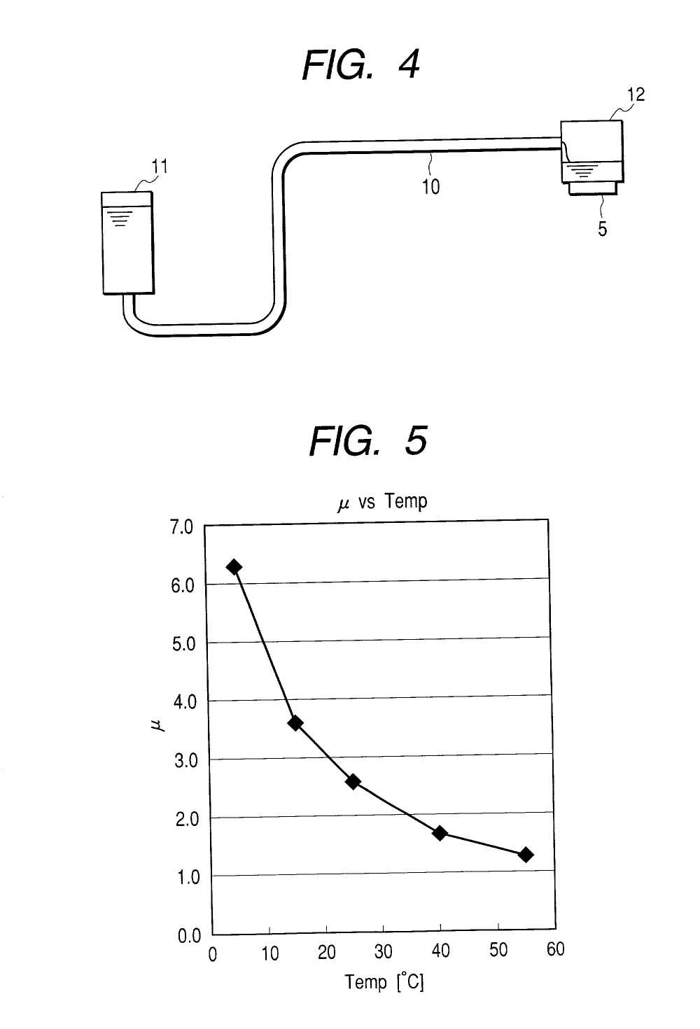

FIG. 4 is a block diagram of a second embodiment of an ink jet recording apparatus of the present invention.

The embodiment shown in FIG. 4 is constituted by adding a pressure smoothing tank to the first embodiment using a tube for connecting an ink tank fixed to a position which is not scanned with a recording head fixed onto a carriage for scanning each other. A serial printer has not only a recording time due to actual ink discharge but also a carriage return time in the case of one-way printing and a non-recording time such as carriage stop or data receiving development in the case of both-way printing. Moreover, in the case of sheet paper recording, the sheet supply and sheet expelling time for each sheet is included in a non-recording time. By setting the capacity of the pressure smoothing tank to an air capacity at which even if a negative pressure rises in a recording time for one scan, the pressure can be recovered to the original pressure within a remaining non-recording time, it is possible to recover the raised pressure up to the original pressure in the remaining non-recording time because the negative pressure-rise speed is small even if an instantaneous ink deficiency occurs due to a low temperature, moderate a pressure change speed, and lower the control accuracy.

In this case, when setting the air capacity to a capacity making it possible to achieve a negative pressure rise speed capable of printing one recording sheet, it is sufficient to control the discharge interval in a recording time whenever recording a control interval by one sheet. Moreover, instead of controlling the discharge interval in a recording time, by keeping a recording speed constant and extending a non-recording time, that is, a stop time, it is possible to suppress the ink flow rate for unit time and a negative pressure rise due to a low temperature.

As described above, according to the present invention, an ink supply quantity is compensated and a supply tube and other constituted flow path are downsized by setting a minimum supply-tube inside diameter in accordance with a typical ink temperature in accordance with an ink jet printer operating environment, calculating the data for temperature in the apparatus every unit time, and when it is determined that a pressure loss increases as an ink viscosity rises at a low temperature and a printing trouble occurs due to ink deficiency, extending a discharge interval according to the determination.

What is claimed is:

1. An ink jet recording apparatus comprising:
a recording head for recording data on a recording medium by discharging ink from a plurality of discharge ports;
a carriage having the recording head mounted thereon for reciprocally scanning the surface of said recording medium;
recording medium carrying means for carrying said recording medium by a predetermined distance in the direction perpendicular to said scanning direction of the carriage each time the carriage reciprocally scans the surface of said recording medium;
an ink storage tank placed in a position where reciprocal scanning by said carriage and carrying of said recording medium by said recording medium carrying means are not affected by the ink storage tank;
a supply tube for supplying ink from the ink storage tank to said recording head; and
said control means for controlling ink discharge states of said recording head in accordance with an image signal input from a host computer; wherein
said control means controls the scanning speed of said carriage in accordance with the temperature of the ink supplied from said ink tank to said ink supply tube.

2. An ink jet recording apparatus comprising:
a recording head for recording data on a recording medium by discharging ink from a plurality of discharge ports;
a carriage having the recording head mounted thereon for reciprocally scanning the surface of said recording medium;
recording medium carrying means for carrying said recording medium by a predetermined distance in the direction perpendicular to the scanning direction of said carriage each time the carriage reciprocally scans the surface of said recording medium;
an ink storage tank placed in a position where reciprocal scanning by said carriage and carrying of said recording medium by said recording medium carrying means are not affected by the ink storage tank;
a supply tube for supplying ink from the ink storage tank to said recording head; and
said control means for controlling ink discharge states of said recording head in accordance with an image signal input from a host computer; wherein
the control means controls a non-recording time during which no ink is discharged from said recording head in accordance with the temperature of the ink supplied from said ink tank to said ink supply tube.

3. An ink jet recording apparatus comprising:
a recording head for recording data on a recording medium by discharging ink from a plurality of discharge ports;
a carriage having the recording head mounted thereon for reciprocally scanning the surface of said recording medium;
recording medium carrying means for carrying said recording medium by a predetermined distance in the direction perpendicular to said scanning direction of said carriage each time the carriage reciprocally scans the surface of said recording medium;
an ink storage tank placed in a position where reciprocal scanning by said carriage and carrying of said recording medium by said recording medium carrying means are not affected by the ink storage tank;
a supply tube for supplying ink from the ink storage tank to said recording head; and
said control means for controlling ink discharge states of said recording head in accordance with an image signal input from a host computer; wherein
said control means controls the repetitive recording scanning frequency of the carriage in accordance with the temperature of the ink supplied from said ink tank to said ink supply tube.

4. The ink jet recording apparatus according to claim 1, wherein a pressure smoothing tank capable of storing a predetermined capacity of ink in order to suppress a negative pressure rise in said supply tube is set between said supply tube and said recording head.

5. The ink jet recording apparatus according to claim 4, wherein the predetermined capacity of said pressure smoothing tank is 1 cc or more.

6. The ink jet recording apparatus according to claim 1, wherein said ink tank comprises a temperature sensor.

7. The ink jet recording apparatus according to claim 1, further comprising recovery system means for recovering the ink discharge state of said recording head to a preferable state by forcibly discharging ink from each discharge port of said recording head.

8. The ink jet recording apparatus according to claim 1, wherein said recording head comprises an electrothermal converting element for converting electric energy into thermal energy to discharge ink by using the film boiling generated in ink by the thermal energy applied by the electrothermal element.

9. A recording control method for an ink jet recording apparatus comprising a recording head for recording data on a recording medium by discharging ink from a plurality of discharge ports, a carriage having the recording head mounted thereon for reciprocally scanning the surface of said recording medium, recording medium carrying means for carrying said recording medium by a predetermined distance in the direction perpendicular to the scanning direction of said carriage each time said carriage reciprocally scans the surface of said recording medium, an ink storage tank placed in a position where reciprocal scanning by said carriage and carrying of said recording medium by said recording medium carrying means are not affected by the ink storage tank, and a supply tube for supplying ink from the ink storage tank to the recording head, and control means for controlling ink discharge states of said recording head in accordance with an image signal input from a host computer, comprising:
a step of lowering the scanning speed of said carriage when the temperature of the ink supplied from said ink tank to said ink supply tube is lower than a reference temperature.

10. A recording control method for an ink jet recording apparatus comprising a recording head for recording data on a recording medium by discharging ink from a plurality of discharge ports, a carriage having the recording head mounted thereon for reciprocally scanning the surface of said recording medium, recording medium carrying means for carrying said recording medium by a predetermined distance in the direction perpendicular to the scanning direction of said carriage each time said carriage reciprocally scans the surface of said recording medium, an ink storage tank placed in a position where reciprocal scanning by said carriage and carrying of said recording medium by said recording medium carrying means are not affected by the ink storage tank, and a supply tube for supplying ink from the ink storage tank to said recording head, and control means for controlling ink discharge states of said recording head in accordance with an image signal input from a host computer, comprising:
a step of increasing a non-recording time during which no ink is discharged from said recording head when the temperature of the ink supplied from said ink tank to said ink supply tube is lower than a reference temperature.

11. A recording control method for an ink jet recording apparatus comprising a recording head for recording data on a recording medium by discharging ink from a plurality of discharge ports, a carriage having the recording head mounted thereon for reciprocally scanning the surface of said recording medium, recording medium carrying means for carrying said recording medium by a predetermined distance in the direction perpendicular to the scanning direction of said carriage each time said carriage reciprocally scans the surface of said recording medium, an ink storage tank placed in a position where reciprocal scanning by said carriage and carrying of said recording medium by said recording medium carrying means are not affected by the ink storage tank, and a supply tube for supplying ink from the ink storage tank to said recording head, and control means for controlling ink discharge states of said recording head in accordance with an image signal input from a host computer, comprising:
a step of increasing the repetitive recording scanning frequency by said carriage when the temperature of the ink supplied from said ink tank to said ink supply tube is lower than a reference temperature.
